(19) United States
(12) Patent Application Publication
(10) Pub. No.: US 2007/0255659 A1
(43) Pub. Date: Nov. 1, 2007

(54) System and method for DRM translation

(76) Inventors: Wei Yen, Los Altos Hills, CA (US); John Princen, Cupertino, CA (US); Raymond Lo, Mountain View, CA (US); Wilson Ho, San Mateo, CA (US)

Correspondence Address: PERKINS COIE LLP, P.O. BOX 2168, MENLO PARK, CA, 94026, US

(21) Appl. No.: 11/416,361

(22) Filed: May 1, 2006

(51) Int. Cl. G06Q 99/00

(52) U.S. Cl. 705/51

(57) ABSTRACT

A technique for DRM translation involves converting first digital content into second digital content. An example of a system according to the technique includes a server that provides a first digital content unit coded with a first digital format and use-right protected by first digital rights management (DRM). The system further includes a translator capable of converting the first digital content unit into a second digital content unit coded with a second digital format and use-right protected by second DRM.

### BACKGROUND

Digital Rights Management (“DRM”) is a group of technologies designed to enforce usage contracts between a consumer of digital content and the providers of digital content. A variety of different means are used to enforce these contracts.

When a contract is entered for the use of digital content a license agreement is often packaged along with the digital content. A license for digital content is sometimes referred to as an eTicket. The license may contain information about what usage provisions have been included and agreed to between the provider and user. This license information is usually designed to work with a specific DRM and effectively limits the use of the content to systems compatible with the specific DRM or the usage rules contained within the license are stripped out and unable to be enforced.

### SUMMARY

The following embodiments and aspects thereof are described and illustrated in conjunction with systems, tools, and methods that are meant to be exemplary and illustrative, not limiting in scope. In various embodiments, one or more of the above-described problems have been reduced or eliminated, while other embodiments are directed to other improvements.

A technique for DRM translation involves converting first digital content into second digital content. An example of a system according to the technique includes a server that provides a first digital content unit coded with a first digital format and use-right protected by first digital rights management (DRM). The system further includes a translator capable of converting the first digital content unit into a second digital content unit coded with a second digital format and use-right protected by second DRM.

The translator may be configured to convert the content data into a different format. The translator may also cache content data locally so that it can avoid unnecessary transfers.

The DRM translator converts the license information and if needed formats the payload for use in a different DRM from what it is currently compatible. It may be configured also to verify digital authentication signatures to increase confidence that the content is legitimate. The translator may also be configured to digitally sign payloads so that they can be more easily verified by users as to their legitimacy.

### BRIEF DESCRIPTION OF THE DRAWINGS

Embodiments of the invention are illustrated in the figures. However, the embodiments and figures are illustrative rather than limiting; they provide examples of the invention.

FIGS. 1A and 1B conceptually depict examples of dataflow in a DRM translation.

FIG. 2 depicts an example of dataflow in a DRM system.

FIG. 3 depicts an example of dataflow in a DRM system.

FIG. 4 depicts an example of dataflow in a DRM system.

FIG. 5 depicts an example of dataflow in a DRM system.

FIG. 6 depicts a flowchart of a method for converting license data to a format that is compatable with a user's DRM.

FIG. 7 depicts an example of a translator system.

FIG. 8 graphically depicts an example of information flow between translation modules of a translator system.

FIG. 9 depicts a flowchart of an example of a method for payload translation.

FIG. 10 is a graphical representation of an example of payload.

### DETAILED DESCRIPTION

In the following description, several specific details are presented to provide a thorough understanding of embodiments of the invention. One skilled in the relevant art will recognize, however, that the invention can be practiced without one or more of the specific details, or in combination with other components, etc. In other instances, well-known implementations or operations are not shown or described in detail to avoid obscuring aspects of various embodiments, of the invention.

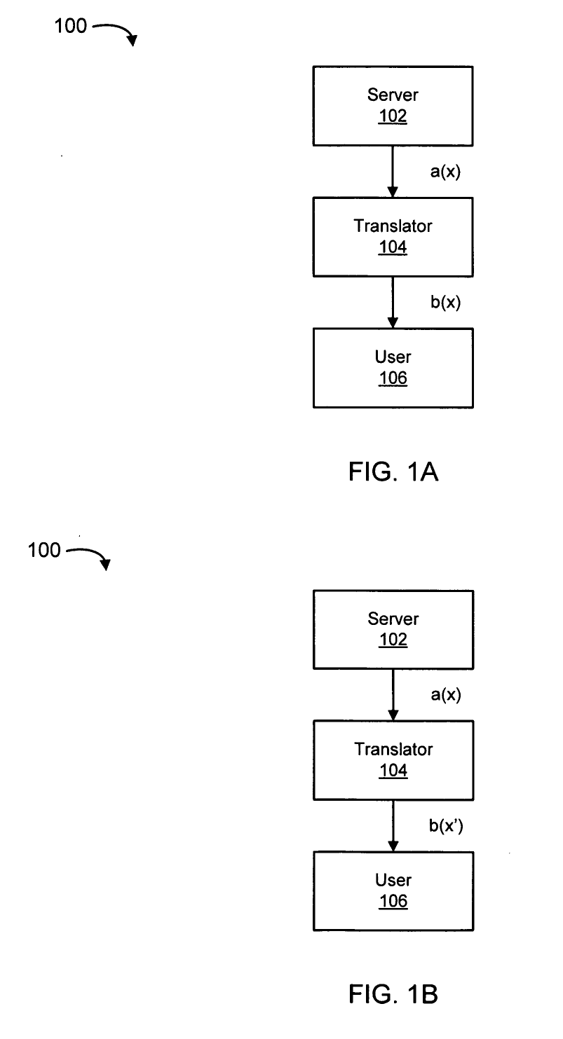

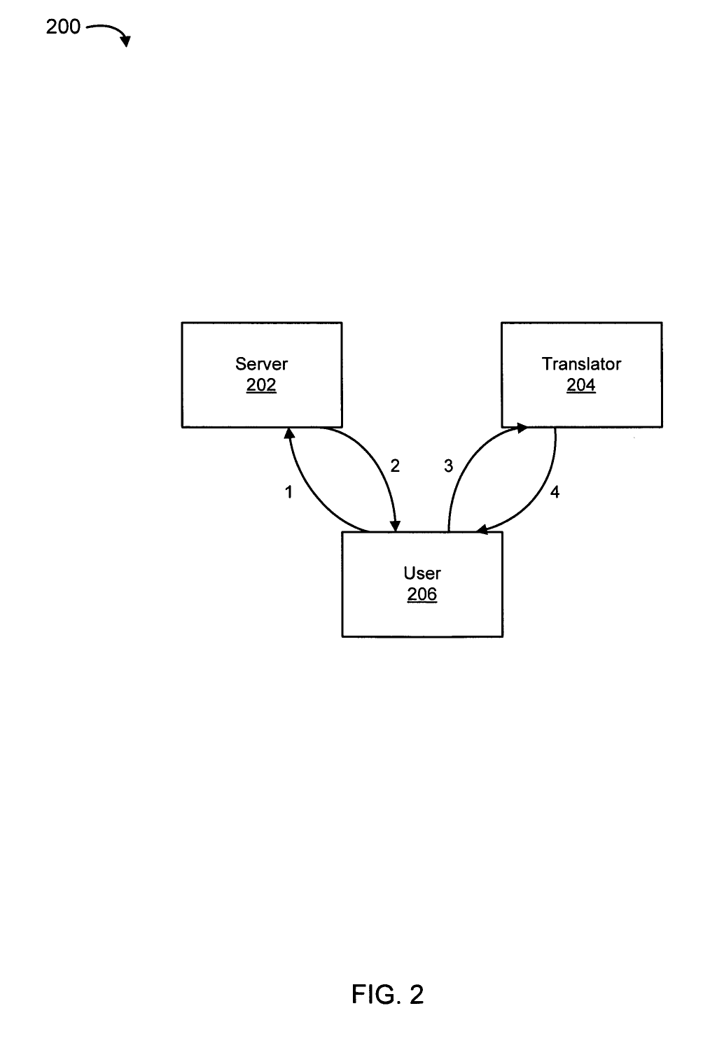

FIG. 1A conceptually depicts an example of dataflow in a DRM translation. The system 100 shows a possible flow of information from a Server 102 to a Translator 104 to a User 106. FIG. 1A is one example of how the data may flow in a DRM translation. Other examples are described later with reference to FIGS. 2-5.

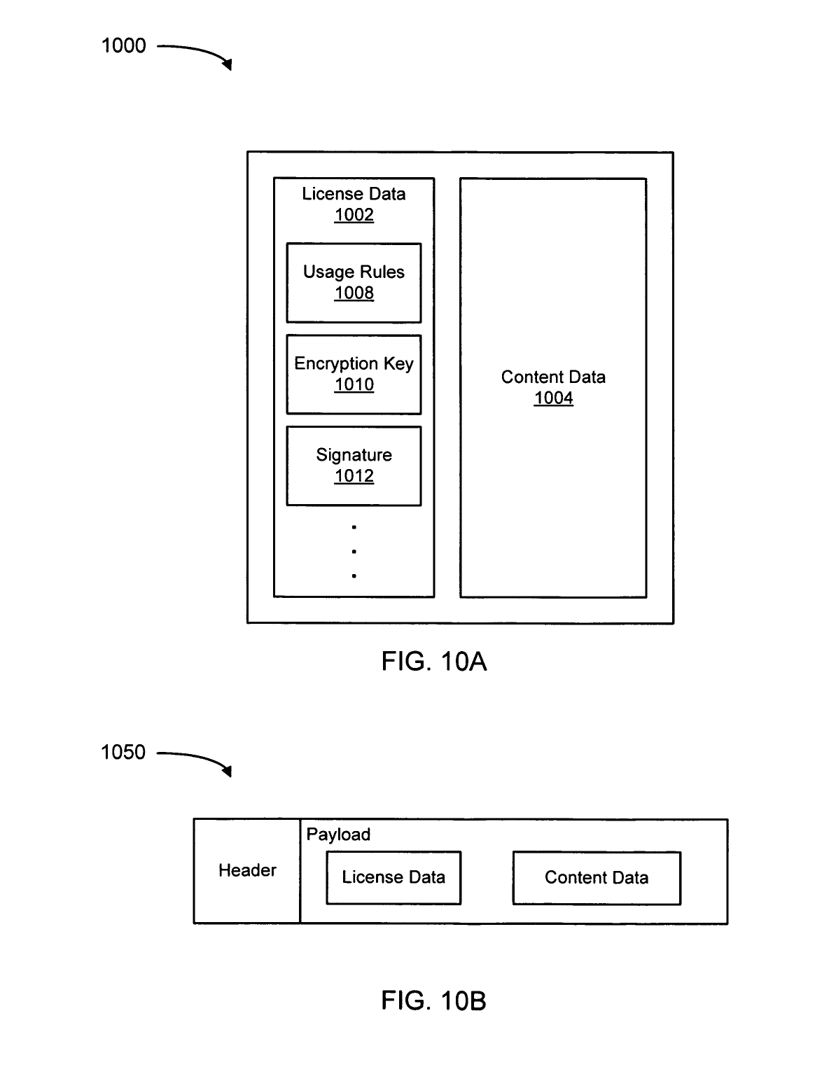

In the example of FIG. 1A, the Server 102 provides a payload represented in the figure as a(x), where “a” represents license data compatible with a first DRM and “x” represents the content data. A payload is discussed later with reference to FIG. 10 and in some embodiments may include more than the license data and the content data. License data may include information about the media and parameters of usage associated with the media (e.g., access rights). In an alternative embodiment, the presence of a valid license alone may indicate usage rights of the content data within the DRM, obviating the need for license data that includes parameters of usage. The license data may be compatible with an individual DRM or multiple DRMs. In an embodiment, the license data may be formatted for use in a specific DRM. In alternative embodiments, the license may be formatted to be compatible with multiple DRMs. The license data may be encrypted for security in a known or convenient manner.

The content data may be provided in a known or convenient format and may be a known or convenient type of information. Some examples of content data include video games, movies, music, etc. Some example music formats include MP3, AAC, WMA, OGG, etc. Some or all of the content data may be encrypted for security and the license data may include an encryption key able to decrypt the encrypted content data. The encryption may be done in any known or convenient manner. The translator can be configured to, for example, convert encrypted data to a new format using the encryption key.

In the example of FIG. 1A, the Translator 104 converts the license information “a” into license information “b”, where “b” is the license data comparable to “a” but compatible with a different DRM. The payload is made compatible for use with a different DRM, while still retaining the usage rights in the license data. In this example the license data “a” is replaced with license data “b”, but it is not necessarily supplanted. As an example, “b” may still include license “a” but also includes a second or any number of additional licenses added to the original. Multiple licenses compatible with multiple DRM systems may be included if desired.

Usage restrictions associated with the license before and after translation are not always the same, and may have little or no relation to one another. For example, digital content that includes songs originally encoded for purchase in a first DRM can be converted for subscription model in the second DRM. Thus, the first DRM can be replaced by the second DRM according to a business logic determination.

The conversion of parameters of usage to a different DRM is not always a “lossless” transfer, meaning that depending on the individual DRMs being converted from and to, it is possible not all contract provisions can be transferred. In these cases the Translator can be configured to make a “lossy” transfer of the usage rights. An example of a lossy transfer is if under one DRM the content data is to be used for 40 hours and if in a different DRM time limits are only recognized as a number of days then limit could be configured to rounded up the timelimit to 2 days or down to 1 depending on the particular implementation.

In the example of FIG. 1A, the User 106 is any entity capable of using the content data under a DRM system. Examples of possible users and content are portable music, movie, or game players in which the content data could be music, a movie, or a video game, retrospectively. The transfer of the information could be by any known or convenient manner with some examples being a component available over a LAN, an internet download, a transfer from a kiosk in a store, etc.

FIG. 1A depicts the User 106, Translator 104, and Server 102 as separate components but this is for illustrative purposes. Each may be logically or physically on the same device. For example the Server 102, Translator 104, and User 106 may all be components on one device, or some combination may be included on one device.

An application usually rises from the difference of the host from which the digital content is purchased and the player by which the content use-right holder wants to play. For example, a user purchases a digital content C.a(x), the Source, from a website X. Digital content C is coded with digital format .a and use-right protected (as well as governed) by DRM x. To exercise rights to C by, e.g., playing C using a (software or hardware) player that employs DRM y and digital Format .b, C.a(x) has to go through a DRM translator to translate it to C.b(y), the Target, before the player can play the content C. It should be noted that a could be the same as .b.

A DRM translator is a program which enables the “eticket Translation” described above. Due to the potential of lacking total compatibility between two DRMs, this translation might not be mathematically lossless even after best efforts by a translator. A DRM Translator should be guarded against malicious attack and alternation in the operating environment, as should the DRM.

FIG. 1B is similar to FIG. 1A except that the content data “x₁” is converted into content data “x₂”. In this example, in addition to the license data being converted as discussed with reference to FIG. 1A, the content data is converted to a different format compatible with the User 106. An example of this is the conversion of an audio file in MP3 into the AAC format. As illustrated in the description of FIG. 1A encrypted content data could be used where the license includes an encryption key. In certain embodiments the translator can convert the encrypted content into another encrypted format and include a new key in the license data.

The conversion of content data to a different format can be initiated automatically if required for the User 106, or could be initiated by manual input. An example of an automatic conversion of content data is the Server 102 detecting a format with which the User 106 is compatible and sending a request to the Translator 104 to convert the data accordingly. In certain embodiments the converted content data may already be cached on the Translator 104, for the purpose of, for example, reducing the bandwidth required for communication between the two. As a further example, the content data may be automatically cached local to the Translator 104 after being converted to a format compatible with the User 106, and thereby negating the need to transfer the content data between the Server 102 and the Translator 104 for subsequent transfers of that content data. In some embodiments the length of time which cached content data is stored locally can be set manually or calculated automatically by logic included in, for example, the Translator 104.

The Translator 104 may also be configured to convert a payload from one file into multiple files, or multiple payloads into one payloads or payloads files into multiple payloads. The conversion could be set to be done automatically for certain types of files or manually. An example of converting one file into multiple payloads is if a movie was so large that it could not fit in a single data unit for download. The Translator 104 may break the movie into multiple blocks that can be sent as multiple packets with payloads that are each a portion of the movie.

FIG. 2 depicts an example of dataflow in a DRM system 200. The system 200 includes a Server 202, a Translator 204, and a User 206. In the example of FIG. 2, the Translator 204 is shown as a separate component but may be included logically or physically as part of the Server 202. In this example, the Translator 204 converts the license data to be compatible with a DRM different from the one with which the license data is currently compatible. The content data may also be converted into a different format if desired. In some embodiments the Translator 204 caches content data files so they do not need to be transferred from the Server 202 to the Translator 204. Additionally, the Translator 204 may convert the content data the first time it is received then cache converted content data so that subsequent transfers are not needed.

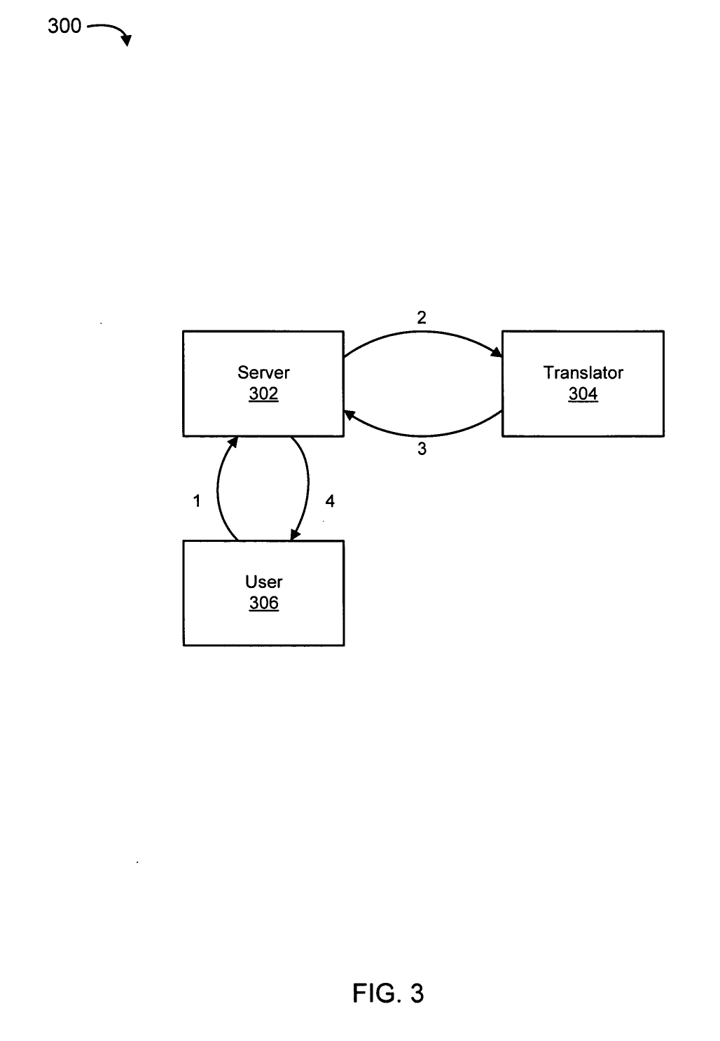

In the example of FIG. 2, four transactions are depicted for illustrative purposes as arrows to or from the User 206. In the example of FIG. 3, transfers are shown as discrete single transfers but in some embodiments there may be multiple transfers, overlapping transfers, or multi-directional transfers. Transfer 1 is from the User 206 to the Server 202. Transfer 2 is from the Server 202 to the User 206. Transfer 3 is from the User 206 to the Translator 204. Transfer 4 is from the Translator 204 to the User 206. It may be noted that the transfers may occur in a different order or may be broken up into sub-transfers, or the timing of different transfers may overlap.

In the example of FIG. 2, transfer 1 may, for example, depict the User 206 sending a request for use of content data. The request may include what usage provisions the User 206 wants or the usage provisions may be automatically implied from the request context. Examples of how usage provisions could be implied from the transfer are the identity of the User 206, past buying behavior, or a default option if no other option is indicated. In another example, the transfer 1 may be a general content request and additional transfers may be used to gather additional required information.

In the example of FIG. 2, transfer 2 may, for example, depict the license and content data being sent to the User 206. As discussed with reference to FIGS. 1A and 1B, the license data may be compatible with a known or convenient DRM and the content data may be in a format that is known or convenient. In a non-limiting embodiment, the content data is provided in an encrypted format. In another non-limiting embodiment both the content data and the license data are encrypted. When encrypted data is included in the payload the license data may include the key to the encrypted content data used to decrypt the content data for use.

In the example of FIG. 2, transfer 3 may, for example, depict the request to convert the payload by User 206. In some embodiments this transfer may be broken into a series of sub-transfers where partial information is sent to the Translator 204. The transfer may also include only the license data if that is all that is required, or the transfer may include the license data and the content data. Transfer 3 may also overlap with transfer 2 if, for example, not all the data is required to begin the conversion process. Transfer 4 may, for example, include the transfer of the converted payload to the User 206.

In certain embodiments a translator is configured to be automatically invoked upon acquisition of a payload by a user. In some embodiments data sent to a server in the acquisition of the payload is used in determining to which DRM to make the payload compatible. In some embodiments a translator is invoked automatically by a user intended to use content data; and the user controls the translator by, for example, determining which DRM to which to make the payload compatible and/or converting the content data to a different format. In some embodiments a translator is configured to be able to make a payload into a plurality of payloads, a plurality of payloads into a payload, or a first plurality of payloads into a second plurality of payloads.

FIG. 3 depicts an example of dataflow in a DRM system 300. FIG. 3 depicts the data being sent to the Translator 304 from the Server 302. The User 306 may also provide, for example, what DRM they are using or also, for example, in what format they would like the content data. In some embodiments this information may be automatically implied from the context of the transfer.

In the example of FIG. 3, the User 306 may send to the Server 302 a request for content data. In response (or, alternatively, at some arbitrary or pre-determined time), the Server 302 may send to the Translator 304 a request to convert payload from a first format into a second format that is compatible with the DRM of the User 306. The Translator 304 may return the converted information to the Server 302, which forwards the converted information to the User 306.

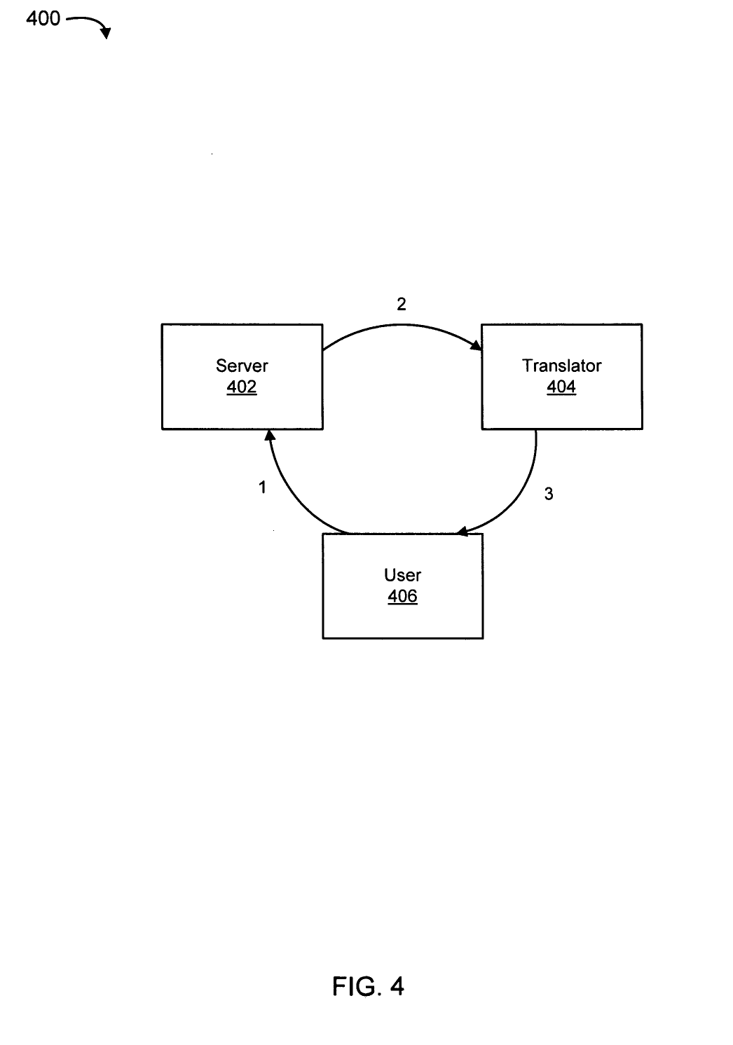

FIG. 4 depicts an example of dataflow in a DRM system 400. Transfers are similar to those described above with reference to FIG. 1. In the example of FIG. 4, the User 406 sends a request for content data to the Server 402. For the purposes of illustration, the payload including the content data is not in the DRM that the User 406 requested so the information is forwarded to the Translator 404. The Translator 404 converts the payload in the manner requested and sends the converted information to the User 406.

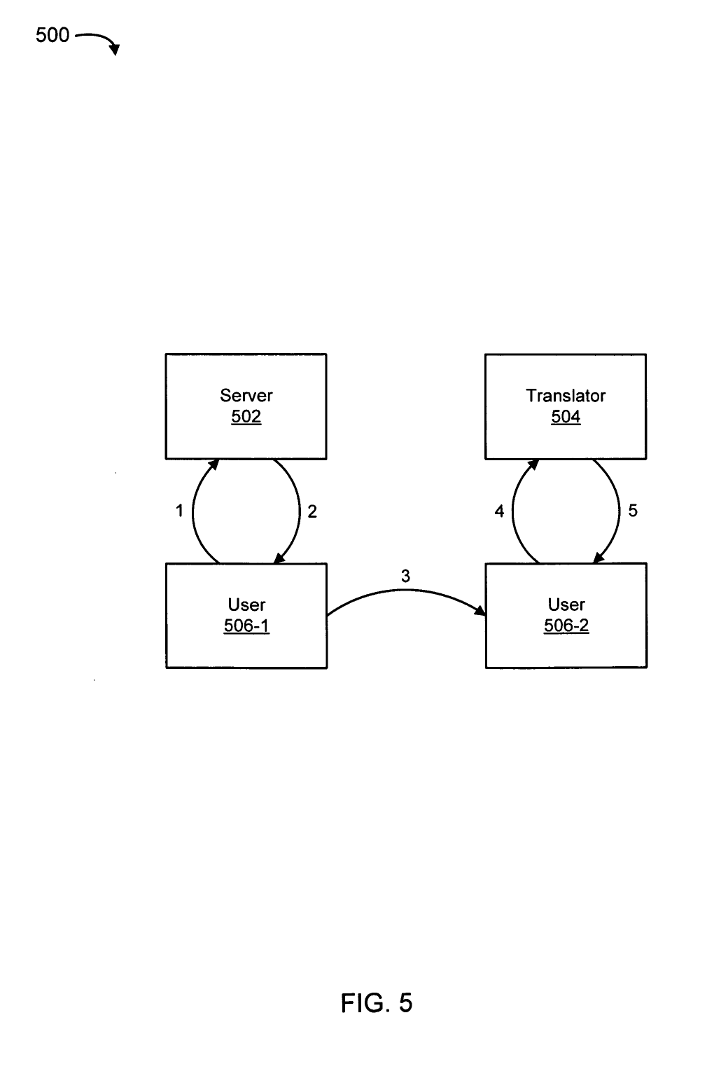

FIG. 5 depicts an example of dataflow in a DRM system 500. Transfers are similar to those described above with reference to FIG. 1. In the example of FIG. 5, there are a User 506-1 and a User 506-2 (referred to hereinafter collectively as users 506) using different DRMs. The User 506-1 requests content data and receives payload including the content data. The User 506-1 sends the payload to the User 506-2, which is, for illustrative purposes, unable to use the content data because, for example, the User 506-2 is not running the same DRM as the User 506-1. The User 506-2 can send the payload to the Translator 504, where the payload can be made compatible with the DRM running on the User 506-2, and the compatible payload returned to the user 506-2.

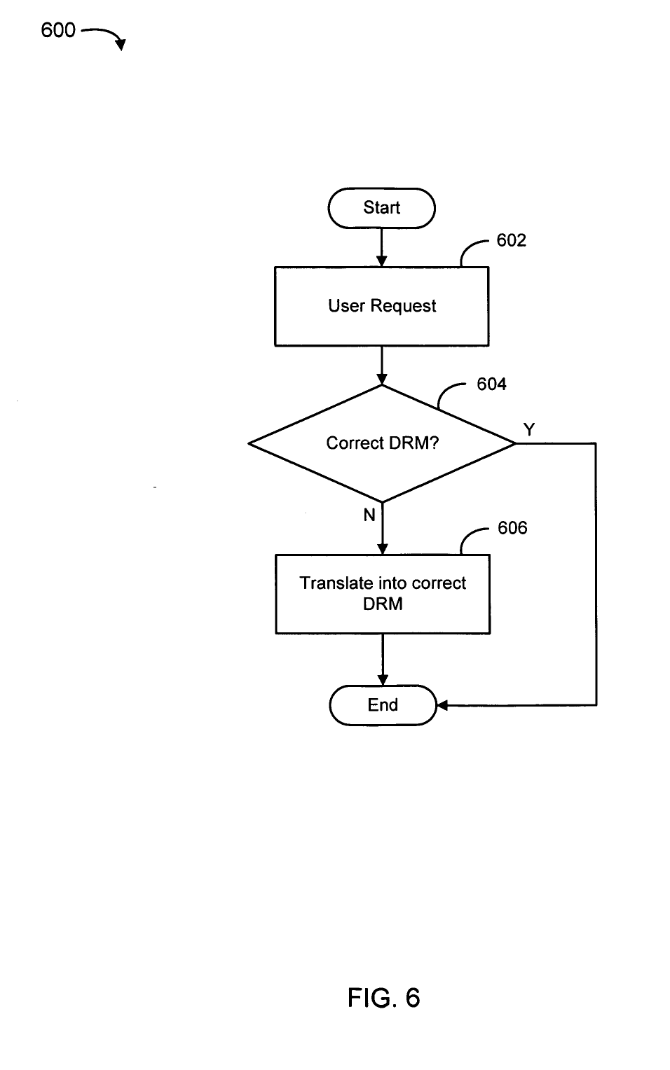

FIG. 6 depicts a flowchart 600 of a method for converting license data to a format that is compatible with a user's DRM. This method and other methods are depicted as serially arranged blocks and decision points. However, blocks and decision points of the methods may be reordered, or arranged for parallel execution as appropriate.

In the example of FIG. 6, the flowchart 600 starts at block 602 where a user sends a request. The request may include, for example, a request to convert payload from a format compatible with a first DRM to a format compatible with a second DRM. For example, the request may include a request to convert content data to a different format. The request may include license data and possibly content data if applicable, or alternatively the license data and/or content data may be transferred to a translator after the determination it is able to make the requested conversion. The translator may, for example, be configured to convert license data to be compatible with multiple combinations of DRMs.

In the example of FIG. 6, the flowchart 600 continues to decision point 604 where it is determined whether the content data, license data, or other payload is in the correct format. If the payload is already in the correct format (604-Y), the flowchart 600 ends. In an alternative embodiment, the flowchart 600 may end if the DRM associated with the request is not recognized or known, the conversion may violate the law (e.g., copyright laws), or the license may be corrupted or have some other defect. In other alternative embodiments content data may be converted to different formats. In these embodiments, whether the content conversion is possible may also be checked.

In the example of FIG. 6, if it is determined that the payload is not in the correct format (604-N), the flowchart 600 continues to block 606 where the payload is translated to be compatible with the proper DRM. The translation may, by way of example but not limitation, only involve substituting new license data. However, depending on the DRM, a partial or entire reformatting of the payload including the content data may be preferable. In some embodiments content data will also be converted to a different format.

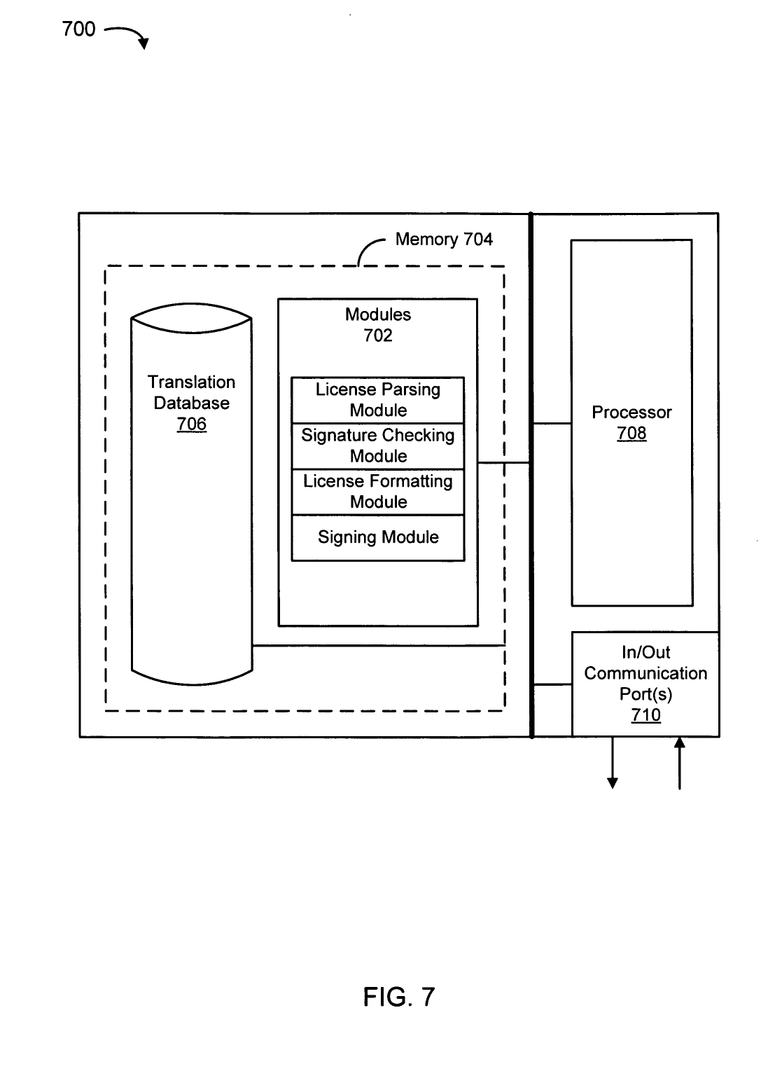

FIG. 7 depicts an example of a translator system 700. In the example of FIG. 7, the system 700 includes memory 704, a processor 708 and an in/out communication port 710. In the example of FIG. 7, the memory 704 includes modules 702 and a translation database 706. The processor 708 may be a known or convenient type including x86 based, PowerPC, SPARC, ARM, etc. The memory 704 may be in a known or convenient type or format including any form of main memory, cache memory, secondary storage, etc., or any known or convenient combination of memory types. The processor 708 and memory 704 are coupled such that the processor 708 is able to execute program modules 702 in memory and access the translation database 706. The in/out communication port may be of any form known and convenient. Some examples of communication ports are wireless radio, USB connection, Ethernet connection, Firewire, etc.

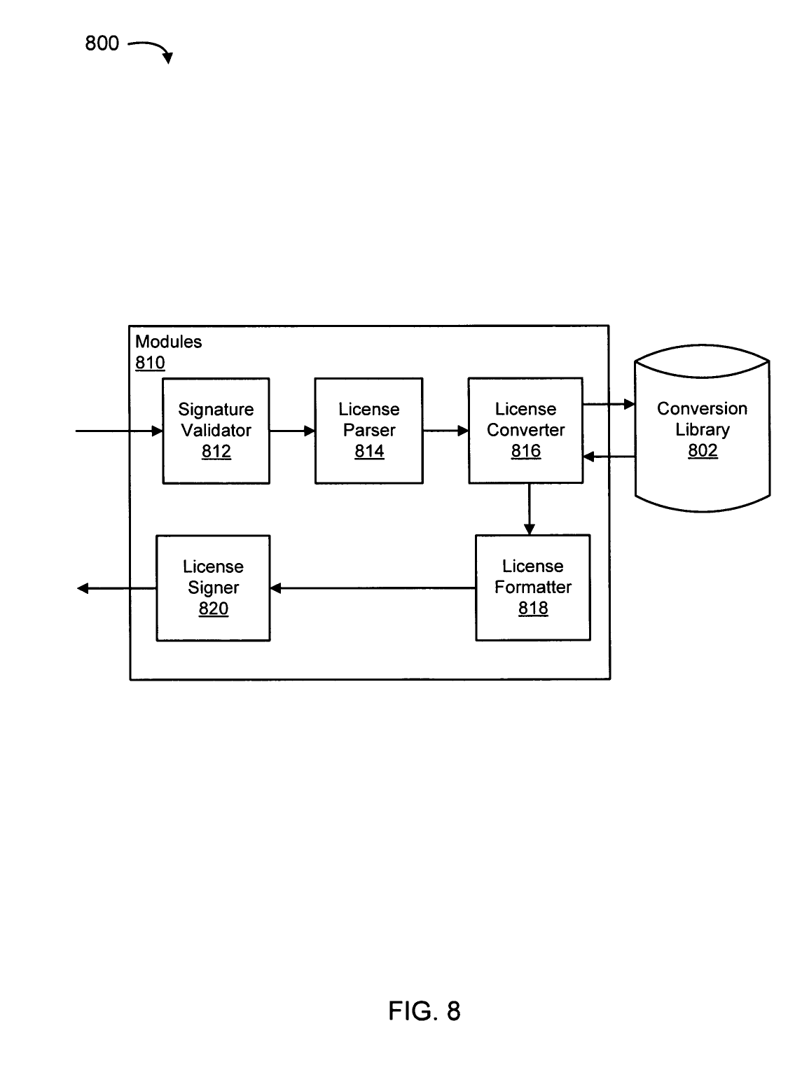

In the example of FIG. 7, in operation, the processor 708 executes the modules 702 as described later with reference to FIG. 8. The modules 702, when executed, are capable of converting a payload compatible with a first DRM into a payload compatible with a second DRM. In this example the modules 702 use information in the translation database 706 to make the conversion. The In/Out port receives the request and sends the converted portions to, for example, a user. In an alternative embodiment the memory 704 may include cached content data, which is either cached after the content data is converted for the first time or alternatively is stored by an outside entity. The cached content data may be stored in any manner known or convenient, including, by way of example but not limitation, in a database.

FIG. 8 graphically depicts an example of information flow between translation modules of a translation system, such as, by way of example but not limitation, the system 700 (FIG. 7). FIG. 8 depicts a system 800, which includes a conversion library 802 and modules 810. The modules 810 include a Signature Checking Module 812, a License Parsing Module 814, a License Conversion Module 816, a License Formatting Module 818, and a License Signer Module 820. This construction is an example only and other implementations are possible where modules are combined or removed or additional modules are added.

In the example of FIG. 8, in operation, the signature checking module 812 verifies the validity of digital signatures on license data. In a non-limiting embodiment the verification takes place local to a translator. In an alternative embodiment an outside source is contacted to ensure the digital signature's validity. Not all payloads need necessarily contain digital signatures; this may or may not depend on the DRM with which the payload is compatible. If a digital signature is invalid there are different possible actions, an example being rejecting the requested conversion or providing a link to a server capable of providing a validly signed payload with the same content data.

In some implementations, digital signature schemes use public-key cryptography. In public-key cryptography, each user has a pair of keys: one public and one private. The public key is distributed freely, but the private key is kept secret and confidential. This technology is well-known and a variety of known or convenient implementations could be used with the techniques described herein.

An example digital signature scheme consists of three algorithms: A key generation algorithm, a signing algorithm, and a verification algorithm

In some implementations, the digital signature is verified using a public key. If the signature is verified, then a translator can be reasonably confident the message was from a server associated with the public key, because the signing algorithm is designed to make it difficult to forge a signature.

In the example of FIG. 8, the License Parser Module 814 removes the usage information from the license data. In a non-limiting embodiment, the License Parser Module 814 determines how to parse the license using information in the Conversion Library 802, which may specify the location of usage information. The use of the Conversion Library 802 for parsing the license information is in accordance with a non-limiting embodiment; in other possible embodiments a library is not used. In embodiments where the library is not used, the License Parser Module 814 may be programmed to parse license information without contacting a library.

In the example of FIG. 8, the License Conversion Module 816 puts the usage parameters into a form which can be used by the second DRM. The form in which the usage parameters are put may or may not be immediately compatible with the second DRM. The information on which parameter forms are usable by the second DRM is contained in the Conversion Library 802. As with the License Parser Module 814, the use of a library is optional and the converter may be programmed to convert without consulting a library. In an embodiment, the first DRM may have specified the content data to be used for 1 day while the second DRM may only except usage limits based on hours. In such an embodiment, the License Converstion Module 816 may convert 1 day into 24 hours.

In the example of FIG. 8, the License Formatting Module 818 formats the converted usage parameters to create a license compatible with the second DRM with the information provided from the License Converter Module 814. The License Formatting Module 818 retrieves the information on how to format the converted parameters into a form compatable with the second DRM from the Conversion Library 802. In an alternative embodiment, the library is optional and the License Formatting Module 818 may already be programmed to format the converted parameters. The License Formatting Module 818 may or may not also be configured to format the entire payload beyond the license if it is required to make the payload compatible with the requested DRM.

In the example of FIG. 8, the License Signing Module 820 digitally signs the payload using a key-generation algorithm, such as was described above by way of example but not limitation, or any known and convenient alternative. In a non-limiting embodiment, the License Signing Module 820 is capable of adding an authentication signature to the license data. This can be implemented using a public key system, such as was described above by way of example but not limitation, or any known and convenient alternative. Not every license must be digitally signed and in some cases it may depend on implementation, configuration, and/or which DRM to or from the license is be converted.

In the example of FIG. 8, the Conversion Library 802 can include information on how to parse a license compatible with a particular DRM, how to convert parameters into a form compatible with a particular DRM, and what license format a particular DRM requires. The Conversion Library 802 is optional and may or may not be required for the operation of the Translator 800. In some embodiments new translation information may be added to the Conversion Library 806 for DRM conversions or existing information in the library can be updated. For example, if the specifications of a particular DRM change, the library can be updated with new information to take into account these changes.

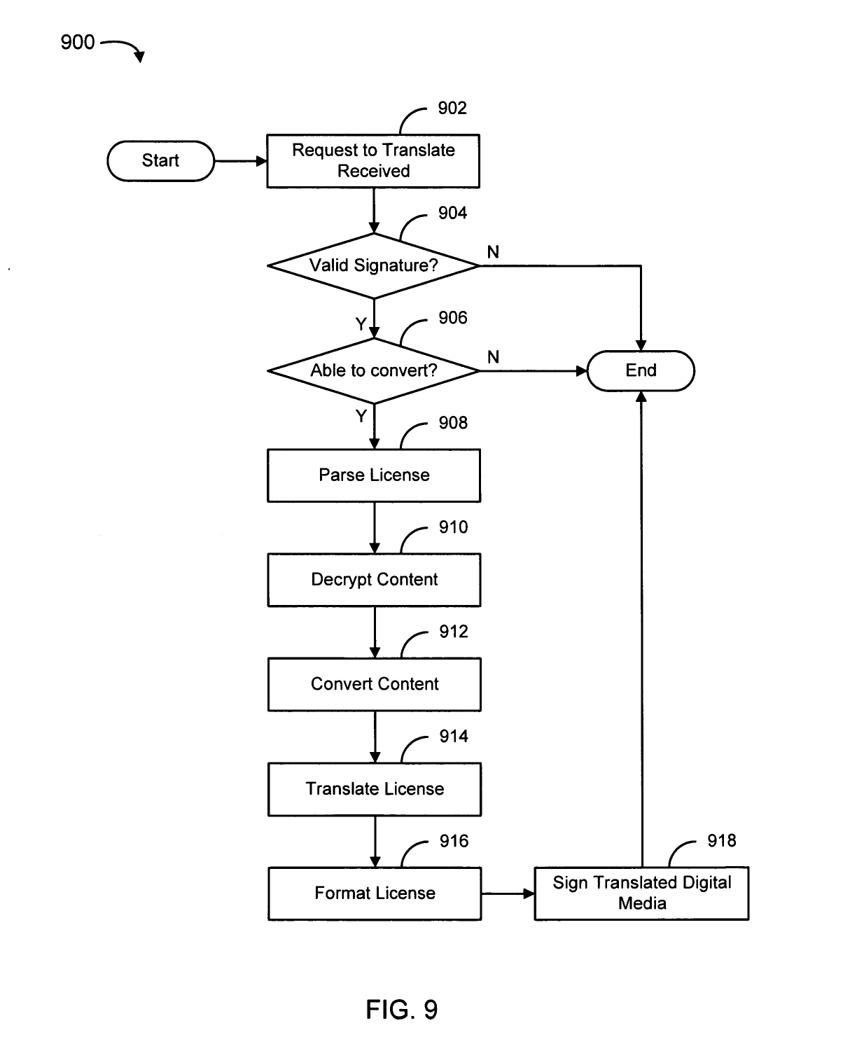

FIG. 9 depicts a flowchart 900 of an example of a method for payload translation. The flowchart 900 starts at block 902 where a request to convert a payload is received. What information this request includes is dependent on the implementation and may include, by way of example but not limitation, only what is being requested, the license, the entire payload, payment information, etc.

In the example of FIG. 9, the flowchart 900 continues to decision point 904, where it is determined whether the signature associated with the payload is valid. Any known or convenient digital signature may be used. There does not necessarily need to be a digital signature on the payload. In the case that there is no signature, the payload may be accepted or rejected depending on the implementation and/or the circumstances of the transaction. If the signature associated with the payload is not valid, the flowchart 900 ends. In another embodiment, additional actions could include notification of a user, directing the user to a location where a validly signed payload containing the same digital content can be obtained, or notification of the content owner. Otherwise, the flowchart 900 continues to decision point 906.

At decision point 906, it is determined whether the license is able to be converted in the requested manner. As discussed previously, for example with reference to FIG. 6, there are possible reasons why the payload is not able to be converted. If the payload is not able to be converted then the flowchart 900 ends. Otherwise, the flowchart 900 continues to block 908.

At block 908 the license data is parsed into parameters of usage. The parameters of usage are dependent on the DRM with which the payload is compatible. The parameters of usage may, for example, describe contract provisions to be enforced for the specific content data. In some embodiments there are no parameters of usage and the presence of a valid license indicates usage rights of the content data.

At block 910 the content data is decrypted using an encryption key contained in the License. This is an example only and known or convenient encryption/decryption techniques may be used.

At block 912 the content data is converted to a requested format. In an embodiment, conversion of the data is not required if the content data is already in the desired format. In other situations the content data may already be cached in the desired format locally and this copy may be used, for example, with no conversion required.

At block 914 the license is translated into a form which is compatible with a different DRM. A lossless conversion between DRMs is not always possible and sometimes information contained in a license is lost from the form a compatible license must take in the new DRM. In some embodiments approximation or logic are used to reduce the loss of license data and the impact of the lossy transfer. As an example of a lossy transfer is if under one DRM the content data is to be used for 40 hours and in the DRM the content is to be used in only recognizes time limits based on number of days then limit could be configured to rounded up the timelimit to 2 days or down to 1 depending on the particular implementation. Under many situations the conversion will be lossless and all information contained in the first DRM can be enforced in the second DRM.

At block 916 the license is formatted to be usable with the requested DRM. In some embodiments, there will be no formatting required if, for example, the license data is already compatible with the DRM. In other embodiments, formatting may be required for more than the license data and the whole payload may require formatting to be compatible with the requested DRM.

At block 918 the payload is digitally signed with an authentication signature. Examples of a digital authentication signature are described by way of example but not limitation with reference to FIG. 8.

FIGS. 10A and 10B are graphical representations of an example of payload 1000 and a packet 1050. In a possible embodiment the payload is split and transmitted in packets, an example of which is shown as packet 1050 in the example of FIG. 10B. In such an embodiment, the packets are combined, when some or all of the packets have been received at a destination, to create a file with which the payload of each packet is associated. In such an embodiment, the packets typically include header information for the routing of the packets and specifying the manner in which they are to be combined.

In the example of FIG. 10A, the payload 1000 includes license data 1002 and content data 1004. The content data 1004 may be encrypted, unencrypted, or partially encrypted as discussed by way of example but not limitation with reference to FIG. 1A. The content data 1004 may be any media to be subject to usage rights and may include music, video games, movies, electronic books, etc. The content may also be in any format, known or convenient, as discussed by way of example but not limitation with reference to FIG. 1A.

In the example of FIG. 10A the license data 1002 includes Usage Rules 1008, Encryption Key for the content data 1010, and an electronic Signature 1012. This is meant as an example only and the license may include more or less or a different combination of information than that shown in the example of FIG. 10A. The Usage Rules 1008 are rules for, for example, the use of the content data 1004 under a compatible DRM. The Usage Rules 1008 may or may not be defined by this DRM. Depending upon the embodiment and/or implementation, there may not be any usage rules in a particular license. For example, the presence of a valid license could be adequate to indicate allowed usage of the content data. Alternatively, specific information could be recorded in the license data 1002 about how, where, and when the content data 1004 may be used.

In the example of FIG. 10A, the Encryption Key 1010 may be the key for decrypting encrypted content data. There is only one encryption key shown, but there may or may not be multiple keys for content data in other embodiments. Additionally in some embodiments, the encryption key itself may be encrypted in some manner and would need to be unencrypted before usage.

In the example of FIG. 10A, the Signature 1012 includes data left by the producer of the payload 1000 to indicate the validity of the content data 1004. The data is difficult to copy and is meant to prove that the data is from the source indicated and is, for example, not forged. The Signature 1012 is shown contained within the license data 1002, but this is an example only and it may be included anywhere in the payload 1000, or even in the header of the packet 1050 in an unusual implementation. There are different applicable ways to create a digital signature, one of which is described by way of example but not limitation with reference to FIG. 8 above.

As used herein, the term “embodiment” means an embodiment that serves to illustrate by way of example but not limitation.

It will be appreciated to those skilled in the art that the preceding examples and embodiments are exemplary and not limiting to the scope of the present invention. It is intended that all permutations, enhancements, equivalents, and improvements thereto that are apparent to those skilled in the art upon a reading of the specification and a study of the drawings are included within the true spirit and scope of the present invention. It is therefore intended that the following appended claims include all such modifications, permutations and equivalents as fall within the true spirit and scope of the present invention.

I claim:

1. A system comprising:
a server capable of providing a first digital content unit, C.a(x), wherein content, C, is coded with a first digital format, .a, and use-right protected by a first digital rights management (DRM), x, wherein the first DRM includes usage parameters;
a translator capable of converting the first digital content unit into a second digital content unit, C.b(y), wherein the content is coded with a second digital format, .b, and use-right protected by a second DRM, y;
wherein, in operation, the server provides the first digital content unit, the translator converts the first digital content unit to a second digital content unit, and the content is executed on a player that is compatible with the second digital content unit.

2. A system as described in claim 1, wherein, in operation, the translator converts multiple first digital content units, C.a1(x1) to C.aN(xN), into the second digital content unit.

3. A system as described in claim 1, wherein, in operation, the translator converts the first digital content unit into multiple second digital content units, C.b1(y1) to C.bN(yN).

4. A system as described in claim 1, wherein, in operation, the translator converts multiple first digital content units, C.a1(x1) to C.aN(xN), into multiple second digital content units, C.b1(y1) to C.bN(yN).

5. A system as described in claim 1, wherein, in operation, the translator is invoked manually by a user.

6. A system as described in claim 1, wherein, in operation, the translator is invoked by a user device upon acquisition of the first digital content unit from the server.

7. A system as described in claim 1, wherein, in operation, purchase data associated with the content is used in making the content compatible with the second DRM.

8. A system as described in claim 1, wherein, in operation, purchase data associated with the content is embedded in an e-commerce transaction associated with the content is concluded or subsequently after the e-commerce transaction is concluded, at a location through which the content is offered.

9. A system as described in claim 1, wherein, in operation, the translator is guided by data selected from the group consisting of: purchasing transaction data, associated transaction data, type of first digital content unit data, type of second digital content unit data, data associated with finding an appropriate second digital content unit into which to convert the first digital content unit, data associated with a player of the content that is compatible with the second digital content unit.

10. A system as described in claim 1, wherein the content data is cached local to the translator after being converted into a format compatible with a user.

11. A system as described in claim 1, wherein at least some of the content data is encrypted and the license data includes an encryption key, wherein the translator is further capable of converting the encrypted content data to a different format using the encryption key.

12. A system as described in claim 1, wherein the usage parameters of the first DRM are replaced by new usage parameters according to a business logic.

13. A method comprising:
receiving a digital medium including license data compatible a first DRM and content data;
translating license data to be compatible with a second DRM;
adding translated license data to the digital medium;
sending the digital medium including the translated license data.

14. A method as recited in claim 13, wherein the digital medium includes an authentication signature, further comprising:
checking the authentication signature for validity;
leaving the license data untranslated if invalid.

15. A method as recited in claim 13, further comprising checking license data to determine if translation is supported for the license data.

16. A method as recited in claim 13, further comprising making the license data into usage parameters, wherein the usage parameters are described in a format which can be translated without knowing the specifics of a source license format.

17. A method as recited in claim 13, wherein the translation of license data is lossy and approximations are used to reduce the loss of license data.

18. A system comprising:
a processor; and memory coupled to the processor, wherein the memory stores program modules executable by the processor;
the memory including:
a license parsing module capable of changing license data into parameters of usage;
a license conversion module capable of making the parameters of usage into license data compatible with a DRM;
a license formatting module capable of recording usage rights recorded in the license data compatible with a first DRM in license data compatible with a second DRM.

19. A system as recited in claim 18, wherein the memory further comprises a signature checking module capable of verifying the validity of a license authentication signature.

20. A system as recited in claim 18, wherein the memory further comprising a signing module capable of adding an authentication signature to the license data.

21. A system as recited in claim 18, wherein the memory further comprises a library including translation data used by the license conversion module.

22. A system as recited in claim 18, wherein the memory further comprises a library including translation data used by the license conversion module, wherein, in operation, the library is updated with new translation data.

23. A system as recited in claim 18, wherein the license conversion module is configured to reduce the loss of usage rights in a lossy creation of license data compatible with the second DRM, wherein the second DRM is not capable of enforcing all usage rights recorded in the license data and information is approximated or omitted to reduce the loss of usage rights information.
